(19) United States
(12) Patent Application Publication
(10) Pub. No.: US 2024/0384981 A1
(43) Pub. Date: Nov. 21, 2024

(54) Assembly for Measuring the Thickness of a Continuous Material Web

(71) Applicants: Matthews International GmbH, Vreden (DE); Matthews International Corporation, Pittsburgh, PA (US)

(72) Inventors: Thomas HACKFORT, Ahaus-Alstätte (DE); Christoph LANSING, Vreden (DE); Carsten KLEINGRIES, Vreden (DE); Gerrit WANTIA, Vreden (DE)

(21) Appl. No.: 18/694,678

(22) PCT Filed: Aug. 26, 2022
(86) PCT No.: PCT/DE2022/100640

§ 371 Date: Mar. 22, 2024

(30) Foreign Application Priority Data
Sep. 23, 2021 (EP) 21198570.0

(51) Int. Cl. G01B 11/06; B65H 16/02

(52) U.S. Cl. CPC G01B 11/0691; B65H 16/023

(57) ABSTRACT

The invention relates to an assembly for contactlessly measuring the thickness of a continuous material web, in particular a flexible, elastic, and/or coated material web, having: a material web which is guided on the surface of a contact body, in particular a contact body which is cylindrical at least in some sections; and a sensor assembly for measuring the thickness of the material web, wherein at least one first sensor is oriented toward an upper face of the material web and at least one second sensor, lying opposite the first sensor, is oriented toward a lower face of the material web. The invention is characterized in that the second sensor is at least partially arranged below the contact region between the material web and the contact body.

The invention relates to an arrangement for non-contact thickness measurement of a continuous, in particular flexible, elastic and/or coated material web, comprising: A web of material guided over a surface of a contact body, in particular at least in sections cylindrical;

A sensor arrangement for measuring the material web thickness, wherein at least one first sensor on a material web top and at least a second sensor is directed opposite the first sensor on a material web bottom.

From document DE 10 2019 121959 B4, a method for producing a plastic film is known, in which molten plastic material is applied from a flat nozzle in a conveying direction and subsequently cools, wherein the flat nozzle in the width direction of the plastic film has a number of nozzle bolts next to each other, With which the size of the discharge gap of the molten plastic material can be influenced, wherein a measuring device for the measurement of the thickness of the manufactured plastic film is arranged in the conveying direction behind the flat nozzle. However, the measuring device for measuring the thickness of the film is located behind the lifting roller in the direction of conveying. This arrangement has the disadvantage that the film is free-floating at the measurement site without a support device and therefore there can be vibrations or a flicker, which can falsify the measurement result.

From document EP o 472 872 A3, a method and a device for determining the thickness of the coating applied by a coating device to a web are known. The thickness of the coating applied to the carrier web is measured on an application roller in front of and behind a contact area of the application roller with the web to be coated and the thickness of the coating removed from the web is determined from the difference of the measured film thicknesses. However, the disclosed device has the disadvantage that the measurement result is dependent on the concentricity properties and vibrations in the application roller.

The invention is therefore based on the object of improving a device or a method for measuring a film thickness in such a way that this provides a more accurate measurement result.

The object is achieved by means of a device or a method having the features of the independent claims.

Accordingly, it is provided that the second sensor is arranged at least in sections below the contact area between the material web and the contact body. The invention thus has the advantage on the one hand that the film in the area of thickness measurement is supported on the one hand by the contact body and therefore vibrations in the film are avoided and on the other hand, That influencing variables induced by the contact body are also automatically calculated out by simultaneously measuring the film thickness at the top and bottom of the film. It may be provided that the contact body has a flat contact area. It may also be provided that the contact body has a convex contact region at least in sections. In particular, it is provided that the material web underside is guided past the surface of the contact body in the contact area. It may be provided that the material web is deflected through the contact area in a predetermined measure, so that the material web before and after the contact area includes an angle of greater than 0°. In particular, it can be provided that the material web in the area of thickness measurement is supported at least in sections, in particular by the contact body. The material web may in particular be a flexible, elastic and/or coated film. The range of thickness measurement can be defined by the overlapping detection ranges of the opposing and toward each other sensors. It may be provided that a plurality of opposite sensor pairs is arranged over the width of the material web. It can be provided in particular that a sensor of each sensor pair is arranged at least in sections below the contact area between the material web and the contact body. It may be provided that the sensors are designed to measure a distance. It may be provided that the first sensor for detecting the distance between the first sensor and the material web top and the second sensor for detecting the distance between the second sensor and the material web bottom is formed. It may be provided that the first sensor and the second sensor are arranged at a predetermined distance to each other.

The thickness of the material web can thus be calculated from the difference between the predetermined distance of the sensors to each other and the sum of the two measured distances of the first and the second sensor.

It may be provided that the second sensor overlaps at least in sections with a cross-sectional surface of the cylindrical unwinding body and is arranged between a rotation axis and the surface of the cylindrical unwinding body. It may be provided that the second sensor is completely located within the cross-sectional area of the cylindrical rolling body.

It can also be provided that the detection region of the second sensor at least in sections comprises a underside of the contact body, in particular an inner surface of the cylindrical rolling body. It may be provided that a detection device of the second sensor faces the underside of the contact body or the inner surface. It may be provided that a detection device of the first sensor is directed to the material web top. It may be provided that the detection ranges of the first and second sensors are exactly opposite each other.

In addition, it can be provided that the cylindrical unwinding body has a cavity in which the second sensor is received. The cavity can be dimensioned such that the second sensor in the cylindrical unwinding body can be arranged statically without coming into contact with the cylindrical unwinding body rotating around the second sensor. Furthermore, the cylindrical roller body may be sleeve-shaped. The cylindrical unwinding body can be mounted rotatably so that the moving material web, in particular free of slip, rolls on it. The cylindrical roller body can be galvanically manufactured.

It may be provided that the surface of the cylindrical roller body has at least one at least in sections in the detection range of the second sensor breakthrough. It may be provided that the material web is guided past the breakthrough. It may be intended that the breakthrough will flow into the cavity.

It may also be provided that the breakthrough extends substantially tangentially along the surface of the cylindrical rolling body. As a result, the breakthrough can extend in the direction of movement of the material web along the material web that has been flung past the breakthrough. The breakthrough may be larger than 0.5 cm wide. It may be provided that the openings are recesses in the material of the cylindrical roller body.

In addition, it may be provided that the breakthrough extends with at least one interruption around the entire circumference of the cylindrical roller body. It may be provided that the breakthrough, in particular periodically spaced apart, has two, three or four interruptions. The openings distributed over the circumference can each have the same length. An interruption may be characterized in that in this region at least one web of the material of the cylindrical rolling body is provided, by means of which the structure of the cylindrical rolling body is stabilized.

It may be provided that the surface of the cylindrical roller body has a plurality of parallel spaced penetrations. The distances between the openings can be the same. The penetrations can be spaced apart from each other by means of bar-shaped spacers. It may be provided that the openings have a larger width than the web-shaped spacing elements.

It can also be provided that the surface of the contact body, in particular the cylindrical rolling body, has a screen structure. The sieve structure may have a plurality, in particular regularly on the surface of the contact body, in particular the cylindrical rolling body, distributed, penetrations. The penetrations can be elongated. The openings can be circular. The openings can be oval. The penetrations can be angular. The penetrations can be square. The openings can be rectangular. The penetrations can be square. The penetrations can be honeycomb-shaped. The area portion of the openings with respect to the total surface area of the contact body may be greater than 50%, preferably greater than 60%, particularly preferably greater than 70%.

In addition, it can be provided that the sensors are attached to at least one linear guide which can be adjusted transversely to the direction of movement of the material web. That Linear guide can be motorized adjustable. The linear guide may also have means for manual adjustment. By means of the linear guide, it is possible to adjust the sensor arrangement transversely to the direction of movement of the material web and to carry out thickness measurements at different locations on the material web. The arrangement may have a control by means of which the linear guide can be controlled. For example, the sensor assembly may comprise two sensor pairs, which can be arranged perpendicular to the direction of movement of the material web spaced from each other and are linearly adjustable perpendicular to this. If a sensor pair of the sensor arrangement now detects a deviation of a predetermined or desired material thickness, the linear guide can be controlled in such a way that the sensor arrangement is laterally adjusted in the direction of the detected deviation. Furthermore, the regulation may include that an emergency stop is initiated if a maximum permissible thickness deviation is exceeded and, for example, a further material feed is stopped.

Furthermore, it can be provided that the cylindrical roller body is mounted on its end faces via thin-ring bearings. Alternatively, any additional bearing that guarantees a high concentricity accuracy can be used to support the cylindrical roller body.

Furthermore, it can be provided that the sensors are arranged stationary in relation to the direction of movement of the material web. This enables the sensor assembly to continuously detect the thickness of the material web passed by. Furthermore, it can be provided that the sensors are adjusted transversely to the direction of movement of the material web continuously or discontinuously. It may be provided that the sensor assembly is adjusted in one direction until an outer edge of the material web is reached, and the sensor assembly is then adjusted in the reverse direction until the opposite edge of the material web is reached, etc.

The invention also relates to a method for non-contact thickness measurement of a material web, in particular flexible, elastic and/or coated, with the steps: Guide a material web over a contact body, in particular at least in sections cylindrical;

Simultaneous detection of a material web top by means of a first sensor and a material web bottom by means of a second sensor, wherein the detection ranges of both sensors are aligned with each other, and wherein the second sensor is arranged at least in sections below the contact area between the material web and the contact body; Determine the thickness of the material web using the acquired sensor values of the first and second sensors.

It can be provided that the material web is deflected through the contact body. By passing the material web and generating a deflection, it can be ensured that the material web lies against the contact body in the contact area and that vibrations in the material web are avoided.

Exemplary embodiments of the invention are explained with reference to the following figures. Where:

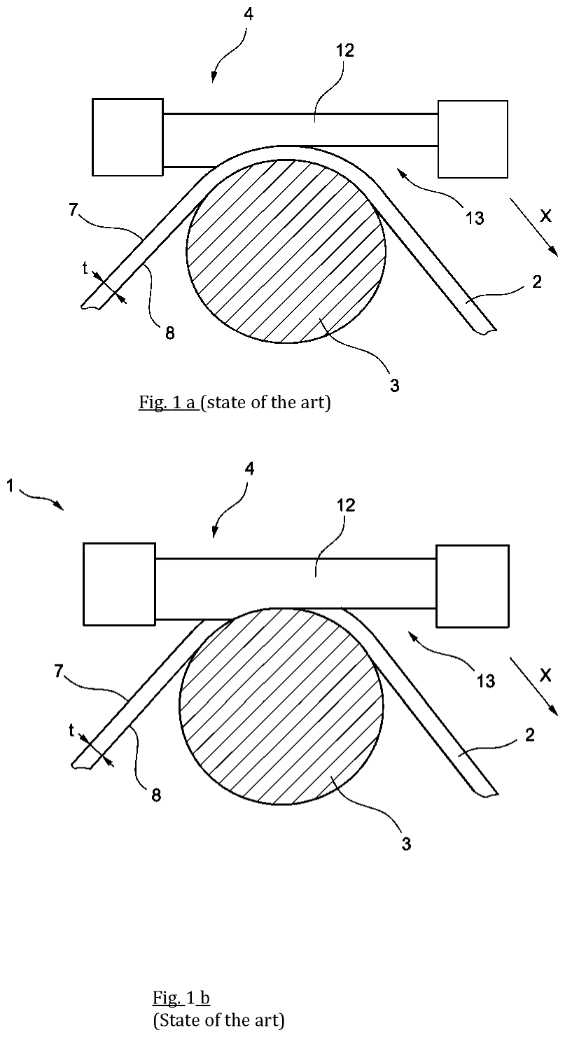

FIG. 1 a) a cross-sectional view of a first method known from the prior art for detecting a material web thickness;

FIG. 1 (b) a cross-sectional view of a second method known from the prior art for detecting a material web thickness;

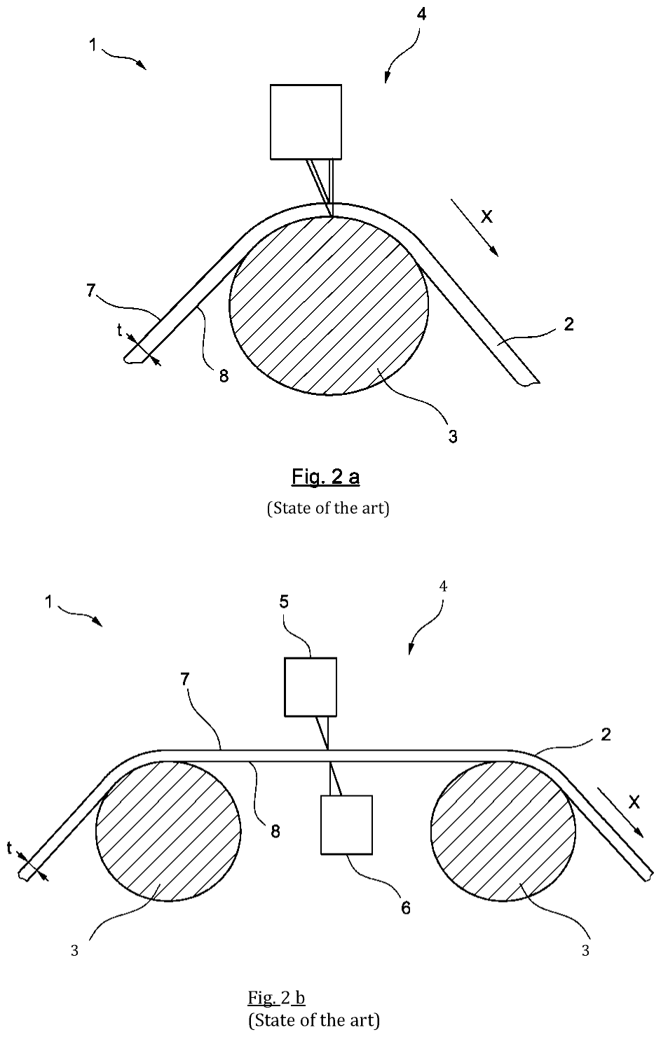

FIG. 2 a) a cross-sectional view of a third method known from the prior art for detecting a material web thickness;

FIG. 2 b) a cross-sectional view of a fourth method known from the prior art for detecting a web thickness;

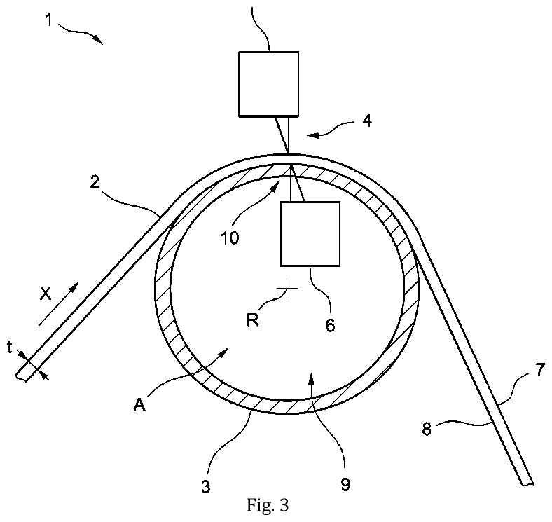

FIG. 3A cross-sectional view of an embodiment of the method according to the invention for detecting a material web thickness;

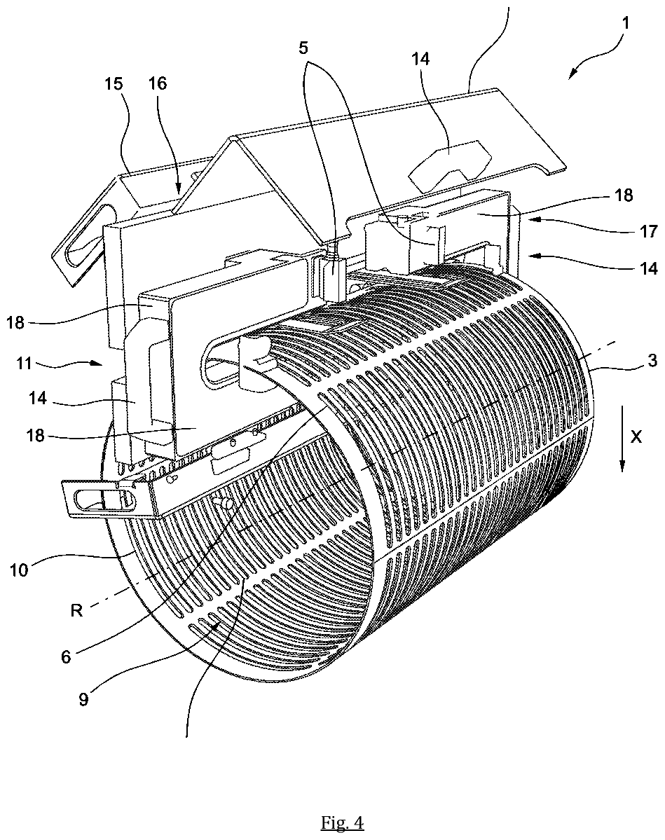

FIG. 4A perspective view of a sensor arrangement according to the invention for detecting a material web thickness.

FIGS. 1a and 1b show arrangements 1 for continuous thickness measurement, in which the thickness measurement of a material web 2 is carried out by means of a light curtain 12, wherein a shading region 13 generated by the material web serves as a basis for determining the material web thickness t. In FIG. 1a, a sensor arrangement 4 is positioned so that the light curtain 12 is flush with the top of a roller 3, over which the material web 2 is guided, so that the roller 3 does not shade the light curtain 12 straight. When leading the material web through the detection area of the sensor assembly 4, the material web 2 projecting over the roller top shadows the light curtain 12 so that the material thickness t of the material web 2 corresponds to the width of the shading area 13. A previously recorded run-out characteristic of the roller is subtracted from this. The disadvantage of this arrangement, however, is that the thickness of the material web can only be calculated indirectly from the concentricity topography of the roller 3. If, for certain reasons, the running characteristics of roller 3 change, this leads to measurement tolerances.

FIG. 1b shows a slightly modified detection method for determining the thickness t of the material web 2 compared to the structure of FIG. 1a. In this detection method, the sensor arrangement 4 is arranged so that That the light curtain 12 beyond the material web also detects an edge portion of the roller 3, so that even without the presence of a material web 2 a predetermined shading area 13 is always generated. The disadvantage of this method, however, is that the thickness t of the material web 2 can only be indirectly derived from the measurement result in this case, since the tolerances of the roller 3 are always included in the measurement tolerances. The tolerances of the roller 3 are determined by the concentricity and the cylindricity deviations of the measuring points next to the material web 2 and on the material web 2.

FIGS. 2a and 2b show two further methods known from the prior art for detecting the thickness t of a material web 2. The structure in FIG. 2a comprises a sensor arrangement 4, which is directed perpendicular to a material web 2 guided in a material movement direction X via a rotating roller 3. The material thickness t is determined by means of a triangulation in which the radiation emitted by the sensor is reflected on the top of the material 7 and on the other hand on the bottom of the material 8, wherein the material thickness t corresponds to the displacement difference of the different reflected beams. Of that stored run-out characteristic of the roller is subtracted. The disadvantage of this arrangement, however, is also that the thickness t of the material web can only be calculated indirectly from the concentricity topography of the roller 3. If, for certain reasons, the running characteristics of roller 3 change, this leads to measurement tolerances.

In contrast, the structure shown in FIG. 2b has two deflection rollers 3, via which the material web 2 is passed successively. Between the deflection rollers 3, a sensor assembly 4 is arranged, which has a first sensor 5 directed to the material web top 7 and a sensor 6 directed to the material web bottom 8, which are arranged perpendicular to the material web 2 in each case and wherein the detection areas of both sensors 5, 6 are aligned. The disadvantage of this arrangement, however, is that the free-floating web of material tends to vibrate or flicker. The smooth running is disturbed by the material web tolerance.

FIG. 3 shows a cross-sectional view of an embodiment of the inventive arrangement 1 for non-contact thickness measurement of a, in particular flexible, elastic and/or coated, material web 2. This comprises a cylindrical unwinding body 3, which is sleeve-shaped and has a continuous cavity 9. The unwind body 3 has a circular cross-sectional surface A and a rotational axis R. A material web 2 is guided via an outer top of the cylindrical unwinding body 3 in a direction of movement X, which is deflected by the cylindrical unwinding body 3 and rolls on this slip-free. The arrangement 1 further comprises a sensor arrangement 4, which has a first sensor 5, which is directed to a material web top 7, and which comprises a second sensor 6, which is directed to a material web bottom 8. The sensors have detection devices, the detection direction of which is perpendicular to the material surface or Bottom. The detection ranges of both sensors 5.6 are exactly aligned with each other so that the thickness t of the material web 2 is measured perpendicular to its main direction of propagation. The second sensor 6 is arranged in the cavity 9 of the cylindrical unwinding body 3 and is located between the outer circumference of the cylindrical unwinding device 3 and its rotation axis R. The cylindrical unwinding body 3 has a plurality of openings 10 on its surface, which in each case lead into the cavity 9. The openings 10 extend substantially tangentially along the surface of the unwind body 3, so that when the cylindrical unwind body 3 rotates, the detection area of the sensor 6 over a maximum time period or circumferential portion of the cylindrical unwind body 3, the material web underside 8 is detected through the opening 10 through. Thus, the cylindrical roller body 3 is basically a sleeve with a screen structure. This has a high concentricity accuracy and can be galvanically manufactured. The great advantage of the device according to the invention is therefore that the material web 2 is supported in the detection range of both sensors 5.6 by the cylindrical unwinding body 3 and therefore no vibration can occur as in a freely floating material web. At the same time concentricity inaccuracies of the cylindrical roller body 3 can be removed at any time, since the detection of the material web 2 at the top 7 and at the bottom 8 takes place simultaneously.

FIG. 4 shows a perspective view of an embodiment of the arrangement 1 according to the invention. As can be seen, the cylindrical unwinding body 3 is formed in the form of a sleeve having a plurality of uniform openings 10. The sleeve 3 has a rotational axis R and is mounted on the front side of each case via thin ring bearings, which are not shown, however. It is intended that the sleeve 3 moves or rotates in a direction of movement X. For better clarity, no material path 2 is shown in the diagram. The openings 10 are designed so that 6 regularly spaced slots are distributed over the circumference of the sleeve 3, which are spaced apart from each other by short material webs. The sleeve has in the axis propagation direction a plurality of such over the circumference distributed penetrations 10, which are in each case laterally regularly spaced from each other. The openings 10 further extend in each case perpendicular to the rotation axis R. The sleeve 3 encloses a cross-sectional surface A and has a cavity 9. The sensor assembly 4 is attached to a sensor carrier 17, which engages the sleeve 3 by means of carrier arms 18 over its edge regions so U-shaped, that the two first sensors 5 attached to the sensor carrier 17 and spaced apart laterally from each other are directed to an outer surface of the sleeve 3 and the two second sensors 6 opposite the first sensors 5 and laterally spaced apart are directed to an inner surface of the sleeve 3. In this case, the first sensors 5 are each attached to an outer carrier arm 18 and the second sensors 6 are each attached to an inner carrier arm 18. The sensor carrier 17 is via a linear guide 11 Transversely to the direction of movement X of the material web 2 can be adjusted laterally. Handgrips 14 are attached to both ends of the sensor carrier 17. As a result, the two sensor pairs can be adjusted over the entire width of the material web 2 in order to be able to carry out thickness measurements at any location. The linear guide 11 via hinges 16 is also hinged to covers 15, which can be folded down to increase the sensor accuracy during operation to darken the detection area. The covers 15 each have a handle 14 for operating the cover 15.

The features of the invention disclosed in the above description, in the figures and in the claims may be essential for the realization of the invention both individually and in any combination.

### REFERENCE CHARACTER LIST

1. Arrangement for non-contact thickness measurement
2. Material web
3. Cylindrical roller body
4. Sensor arrangement
5. First sensor
6. Second sensor
7. Material web top
8. Bottom of the material web
9. Cavity
10. Breakthrough
11. Linear guide
12. Light curtain
13. Shadows
14. Handgrips
15. Cover
16. Hinge
17. Sensor carrier
18. Carrier arm
A Cross-sectional area
t Material web thickness
R Rotation axis
X Movement direction of material web

1. Arrangement for non-contact thickness measurement of a continuous, in particular flexible, elastic and/or coated, material web, comprising:
A web of material guided over a surface of a contact body, in particular at least in sections cylindrical;
A sensor assembly for measuring the material web thickness, wherein at least one first sensor is directed to a material web top and at least one second sensor is directed opposite the first sensor to a material web bottom;
Characterized in that the second sensor is arranged at least in sections below the contact area between the material web and the contact body.

2. Arrangement according to claim 1, wherein the second sensor overlaps at least in sections with a cross-sectional surface of the cylindrical unwinding body and is arranged between a rotation axis and the surface of the cylindrical unwinding body.

3. Arrangement according to claim 1, wherein the detection region of the second sensor at least in sections comprises a underside of the contact body, in particular an inner surface of the cylindrical rolling body.

4. Arrangement according to any one of claim 1, wherein the cylindrical unwinding body has a cavity in which the second sensor is received.

5. Arrangement according to claim 1, wherein the cylindrical unwinding body is formed in a sleeve-like form.

6. Arrangement according to claim 1, wherein the surface of the contact body, in particular of the cylindrical rolling body, at least one at least in sections in the detection region of the second sensor lying through has.

7. Arrangement according to claim 6, wherein the breakthrough extends substantially tangentially along the surface of the cylindrical rolling body.

8. Arrangement according to claim 6, wherein the breakthrough with at least one interruption extends around the entire circumference of the cylindrical unwinding body.

9. Arrangement according to claim 1, wherein the surface of the cylindrical rolling body a plurality of parallel spaced penetrations has openings.

10. Arrangement according to claim 1, wherein the surface of the cylindrical unwinding body has a screen structure.

11. Arrangement according to claim 1, wherein the sensors are arranged stationary in relation to the direction of movement of the material web.

12. Arrangement according to claim 1, wherein the sensors are attached to at least one linear guide which can be adjusted transversely to the direction of movement of the material web.

13. Arrangement according to claim 1, wherein the cylindrical unwinding body is mounted on its end faces via thin ring bearings.

14. Method for non-contact thickness measurement of a continuous, in particular flexible, elastic and/or coated material web (2) with the steps:
guide a material web over a contact body, in particular at least in sections cylindrical;
simultaneous detection of a material web top by means of a first sensor and a material web bottom by means of a second sensor, wherein the detection areas of both sensors are aligned with each other, and
wherein the second sensor is arranged at least in sections below the contact area between the material web and the contact body;
determine the web thickness using the acquired sensor values of the first and second sensors.

15. A method according to claim 14, wherein the material web is deflected by the cylindrical unwinding body.
